(19) United States
(12) Patent Application Publication
(10) Pub. No.: US 2004/0030659 A1
(43) Pub. Date: Feb. 12, 2004

(54) Transaction system and method

(76) Inventor: Wilson How Kiap Gueh, Singapore (SG)

Correspondence Address: FOLEY & LARDNER, 321 NORTH CLARK STREET, SUITE 2800, CHICAGO, IL, 60610-4764, US

(21) Appl. No.: 10/296,273

(22) PCT Filed: May 25, 2001
(86) PCT No.: PCT/SG01/00102

(30) Foreign Application Priority Data
May 25, 2000 (AU) PQ 7758
Nov. 21, 2000 (AU) PR 1598

(51) Int. Cl. G06F 17/60; H04K 1/00; H04L 9/00

(52) U.S. Cl. 705/67

(57) ABSTRACT

The present invention provides a system and method for authenticating a financial transaction on an on-line network, the method involving: receiving a transaction request from a purchaser including unique information relating to the purchaser; authenticating the transaction request, and if authenticated, providing the purchaser with a transaction number, different from the purchaser's credit/debit card number, which the purchaser uses in order to effect the financial transaction.

### TECHNICAL FIELD

The present invention relates to a system and/or method in the field of commercial transactions and notably to the field of electronic transactions in an on-line environment. The present invention has particular application to Internet banking and e-commerce operating systems.

### BACKGROUND ART

With the advent of on-line networks, such as the Internet, commercial transactions in an on-line environment have become increasingly prevalent. Innumerable on-line sites now exist offering users a multitude of products and services that may be purchased via electronic transactions.

In undertaking on-line transactions, there is a general demand by users for such transactions to maintain their anonymity and privacy, as well as the assurance that personal financial information is not being compromised, particularly in relation to the disclosure of credit card numbers and their associated expiry date information.

For example, users wanting to purchase goods and services from a particular site are usually required to submit their credit or payment card details to the merchant. A problem with this approach is that the merchant is then availed of the user's credit details, so that the possibility exists for the merchant to misuse the details. For example, should a person's credit card number and related expiry date be obtained by a disreputable person, such as an errant merchant or computer hacker, then that person could use the number and date to make purchases on-line without the consent of the true owner of the card.

Credit card fraud is a particular problem for merchants, as most credit providers have a “card not present” policy whereby on-line merchants are held r sponsible for all fraudulent transactions. Therefore many on-line merchants suffer significant losses in revenue due to this policy.

From the users' point of view, when their credit card number is stolen, the credit provider deactivates the number and a new account installed. This process is time consuming, costly and generally disruptive for the account holder, as the existing credit card number cannot be used for any further transactions once the number is deactivated.

One previous attempt to solve the security problem has been Secure Electronic Transaction (SET) Technology. This technology requires a credit card to be authenticated via a smart chip reader installed on the user's computer system before the impending transaction. It is an on-line equivalent of presenting a credit card to a merchant to approve a transaction. While this technology is considered to provide a reasonably secure form of on-line transaction authentication, since the installation of a specialised card reader is required, the user's secure use of their credit card is restricted, as they are unable to purchase goods and services from other computer systems without such a reader installed.

In addition, there has been a general reluctance from users to accept the use of such specialised hardware for on-line transactions.

Another approach has been the authentication of the user via digital certificates that are first encrypted and then authenticated by the on-line merchant. A limitation of this technology is that there is to-date no single industry-wide standard for these certificates, so the user may end up with various types of different digital certificates to be used with various merchants. In addition, the system may be abused by disreputable merchants who misuse such certificates for unauthorized transactions.

There is therefore a need for a transaction system and/or method that provides users with an improved degree of anonymity, privacy and/or security.

The present invention seeks to overcome or alleviate at least one of the problems of the prior art.

### SUMMARY OF THE INVENTION

According to a first aspect the present invention provides a method of authenticating a transaction between a purchaser and a merchant on an on-line network, including the steps of:

the purchaser sending a transaction request from a mobile telephone having a SIM card;

receiving said transaction request from said purchaser including unique identification information relating to said purchaser; and

authenticating said transaction request and, if authenticated, providing the purchaser with a transaction number, different from the purchaser's credit/debit card number, which the purchaser uses in order to effect the transaction;

wherein said unique identification information relating to the purchase is obtained via said SIM card.

Thus, the user's identification can be verified according to, for example, the unique number of the SIM card. It will be understood that “purchaser” may include any user wishing to effect a payment, and that “merchant” may include any party to whom the purchaser wishes to make that payment. The payment could of course be for a good or a service, but it might also be intended to settle an existing debt, such as by paying a bill, so that a past purchase is settled, constitute an advance payment, or even merely to effect funds transfer between accounts. It will also be appreciated by those in the art that the transaction number (which may also be referred to as a “mutant number”, “mutant account number”, “mutant payment number” or “mutant card number”, referring to its generally being different each time it is used) need not have any relationship with the purchaser's “genuine” credit/debit card or account number, or indeed that such a “genuine” credit/debit card number exists. It is envisaged that a credit account, for example, could be operated exclusively by the method (or system below) of the present invention, and that the transaction numbers, typically generated as required, could be the only numbers used to access that account. Further, the transaction number need not be generated from, or modified from, the purchaser's credit/debit card number.

Preferably the unique identification information relating to the purchase is obtained via said SIM card and a PIN entered by said purchaser.

Preferably, when the request is submitted from a device with a display (such as a computer screen), said identification information includes one or more hotspots, each hotspot located at a respective predetermined location adjacent to a character of said identification information.

In one embodiment, the method includes deactivating said transaction number after a predetermined time period, so that said transaction number is made unusable even if not yet used.

According to a second aspect, the present invention provides a system for undertaking transactions-in an on-line environment, including:

a plurality of credit cards, such that the cards have identical physical credit card numbers;

an authentication system for authenticating purchases to be made using any respective one of said credit cards, said system being operable:

to receive and authenticate unique identification information relating to and provided by the user of said respective credit card, said unique identification information being not physically associated with said respective said credit card; and

for a positive authentication, to provide said user with a transaction number to be provided to a merchant as a credit card number, such that the transaction number is different from the physical credit card number.

Thus, all the credit cards have what could be termed a “universal” number that is identical. The particular user or purchaser is identified from the identification information and the issued transaction number can then be associated with that user.

Preferably the transaction number is randomly generated and only able to be used for a single transaction.

Preferably the method further includes a transaction confirmation generating means for generating a transaction confirmation to be sent to the owner of the credit/debit card via one or more prearranged network-connected addresses, such as an email address.

Preferably the plurality of credit cards each includes an off-line credit card number that may only be used for off-line credit transactions.

Preferably the off-line credit card number is stored on said credit card.

Preferably the off-line credit card number is stored on a magnetic strip on said respective credit card, in a chip embedded on said respective credit card, or both on a magnetic strip on said respective credit card and in a chip embedded on said respective credit card.

Preferably each of the credit cards has a separate credit account for on-line transactions and off-line transactions.

In another aspect the invention provides a method of authenticating a transaction between a purchaser and a merchant on an on-line network, wherein the purchaser is requesting the transaction from a mobile telephone with a SIM card, including the step of:

authenticating the purchaser's credit via said SIM card.

Preferably the method includes authenticating the purchaser's credit via the SIM card and a unique PIN.

In yet another aspect the invention provides a method for a purchaser to effect a transaction with a merchant, said method involving:

said purchaser submitting a request for a transaction number, said request including identification information relating to said purchaser;

said purchaser receiving said transaction number if said request has been authenticated; and

providing said transaction number to said merchant in order to effect the transaction;

wherein said transaction number includes a portion of a genuine account or card number of said purchaser or a portion of a common account or card number of said purchaser.

Preferably the common account or card number is specific to a particular financial institution, or a particular merchant.

In another aspect the invention provides a system for enabling a transaction between a purchaser and a merchant, said system having:

purchaser authenticating means operable to receive a request for a transaction number from said purchaser via a mobile telephone having a SIM card, said request including identification information derived from said SIM card, and to authenticate said purchaser based on said identification information; and

a transaction number generator operable to generate said transaction number associated with said purchaser for use by said purchaser in effecting said transaction.

Preferably the unique identification information relating to the transaction is derived from said SIM card and a PIN provided by said purchaser.

Preferably the transaction number is different from a credit/debit account or card number of said purchaser.

Preferably the transaction number includes a portion of a genuine account or card number of said purchaser, or a portion of a common account or card number of said purchaser.

Preferably the common account or card number is specific to a particular financial institution, or a particular merchant.

In a further aspect, the invention provides a method of authenticating the identity of a user to a server in an on-line or other telecommunications environment, including the steps of:

establishing a user account with an associated user identification information and receiving, from said user, a password;

generating a pool of pseudo-passwords on the basis of said password and a code derived from said password;

receiving a log-in request from said user at a user device including said user identification information;

activating a pseudo-password from said pool of pseudo-passwords and generating a set of one or more numbers, wherein one of said set of numbers is derived from said code according to a rule;

transmitting to a user device said set of numbers;

entering said password into said user device and modifying said set of numbers according to said password and an inverse of said rule at said user device to produce a modified set of numbers;

transmitting said modified set of numbers to said server, said modified set of numbers including said code if said password has been entered correctly by said user;

releasing said selected pseudo-password and effecting user log-in if said modified set of numbers includes said code.

Preferably the password includes a hotspot with a position in or relative to said password.

Preferably the method includes locating said code in said set of numbers on the basis of said hotspot position.

Preferably the code is generated from a first hash value derived from said password independent of said position of said hotspot and a second hash value derived from said position of said hotspot.

Preferably the method includes generating said code by means of a session specific rule.

In another aspect the invention provides a method of effecting a transaction between a purchaser and a merchant, involving:

providing purchaser account information to said merchant;

said merchant requesting transaction approval from a credit issuer or agent thereof;

said credit issuer sending an authentication request to said purchaser; and

said purchaser responding to said authentication request by sending authentication data to said credit issuer;

wherein said authentication data comprises a predetermined first portion of a password or phrase supplied by said purchaser and a requested second portion of said password or phrase.

Thus, the password can provided in two portions in separate submission channels (such as two data input fields, windows or devices).

In still another aspect, the invention provides a method of effecting a transaction between a purchaser and a merchant, involving:

receiving a request for transaction approval from said merchant;

sending an authentication request to said purchaser; and

receiving authentication data from said purchaser;

wherein said authentication data comprises a predetermined first portion of a password or phrase supplied by said purchaser and a requested second portion of said password or phrase.

Preferably the first portion is delimited by a hotspot previously supplied with said password or phrase by said purchaser.

In another aspect, the invention provides a method of authenticating the identity of a user to a server in an online or other telecommunications environment, including the steps of:

receiving a log-in request from said user including unique information relating to said user;

authenticating the log-in request, and if authenticated, providing said user with a log-in number, which said user uses in order to log-in to said server.

The invention also provides a method of authenticating the identity of a user to a server in an online or other teleconununications environment, including the steps of:

sending to a mobile telephone or other portable communications device of said user an authentication request;

deeming user identity verified if said user responds to said request by sending a suitable response from said mobile telephone or other portable communications device.

Preferably the server sends said request and receives said response via a gateway corresponding to said mobile telephone or other portable conmnunications device. More preferably the gateway is an iWAPGS server.

Preferably the method includes requiring that said response be received within a predetermined time after said request is sent and deeming any subsequent response to said request unsuitable.

The invention also provides a method of effecting a transaction between a purchaser and a merchant, involving:

providing purchaser account information to said merchant;

said merchant requesting transaction approval from a credit issuer or agent thereof;

said credit issuer sending an authentication request to said purchaser; and

said purchaser responding to said authentication request by sending authentication data to said credit issuer;

wherein said authentication data comprises a predetermined first portion of a password or phrase supplied by said purchaser and a second portion of said password or phrase, said first portion being submitted over a first channel and second portion being submitted over a second channel distinct from said first channel.

The first and second channels may be separate portions of a computer screen, but preferably at least one of the first and second channels comprises a mobile telephone or other portable communications device.

More preferably the first channel is a mobile telephone or other portable communications device and said second channel is a computer.

The first and second portions preferably each comprise separate portions of the password or phrase that, when juxtaposed, constitute the entire password or phrase.

### BRIEF DESCRIPTION OF THE DRAWINGS

Illustrative embodiments of the present invention will now be described, by way of example, with reference to the accompanying drawings, in which:

FIG. 1 illustrates an example of an order form on a merchant's on-line site for use with a system for effecting transactions according to a first embodiment of the present invention;

FIG. 2 illustrates an example of the type of billing information to be entered to place an order at a merchant's on-line site according to an embodiment of the invention;

FIG. 3 illustrates an example of a window that may be presented to the user to provide a connection with a credit provider according to an embodiment of the invention;

FIG. 4 illustrates the provision of a transaction number to a user for use in an on-line transaction according to an embodiment of the invention;

FIG. 5 illustrates an example of the user using the transaction number on a merchant site to complete a transaction according to an embodiment of the present invention;

FIG. 6 is a schematic representation of a system for effecting financial transactions according the first embodiment of the present invention;

FIG. 7 is a schematic representation of a detail of the system of FIG. 6 illustrating the manner in which user identify is established;

FIG. 8 is a schematic representation of a detail of the system of FIG. 6 illustrating the provision of a transaction number;

FIG. 9 is a schematic representation of a detail of the system of FIG. 6 illustrating the inclusion of the time of request of a transaction number in credit authorization;

FIG. 10 is a schematic representation of a reserved list of transaction numbers in a system for effecting financial transactions according to a further embodiment of the present invention;

FIG. 11 illustrates the manner in which access to the reserved list of FIG. 10 is initiated;

FIG. 12 illustrates the generation and use of a morph code to select a transaction number according to the further embodiment;

FIG. 13 illustrates the transmission of the transaction number to a user according to the further embodiment;

FIG. 14 illustrates the swapping of reserved lists of transaction numbers between users according to the further embodiment;

FIGS. 15A and 15B illustrate the insertion of hotspots into user identification information in a system for effecting financial transactions according to a further embodiment of the present invention;

FIG. 16 illustrates the augm ntation of user identification information with personal information in a system for effecting financial transactions acc rding to a still further embodiment of the present inv ntion; and

FIGS. 17A, 17B and 17C illustrate the augmentation of user identification information with personal information inserted in the password field in a system for effecting financial transactions according to a yet further embodiment of the present invention.

### DETAILED DESCRIPTION

According to a first embodiment of the present invention, there is provided a system whereby electronic payment cards, such as credit cards are provided to a plurality of users, whereby the number appearing on the card is common to all such cards issued under the system. For present purposes, this number will be referred herein as the universal number. One or more suitable credit providers, such as a bank or other credit institution would issue these cards.

These cards are be individualized by virtue of an alternative identification means. For example, the user may have a unique user ID and/or password.

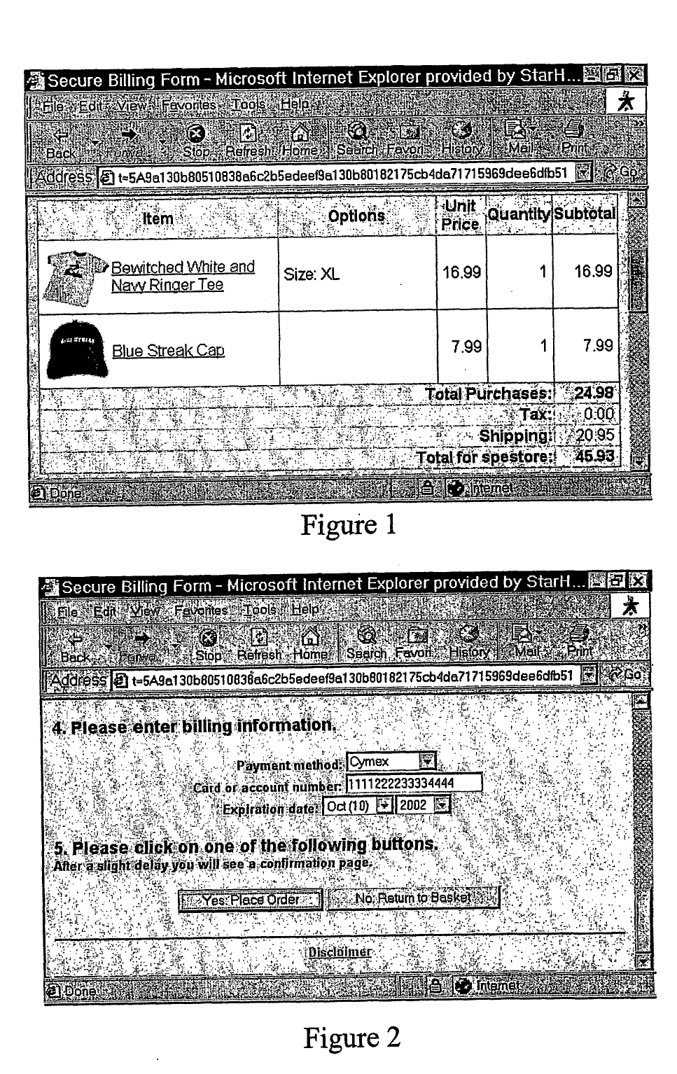

As an example of how such a payment/credit card would be utilised, a user wishing to make a purchase on-line would proceed to a particular merchant site. The user may access the site by any suitable means, such as a computer, mobile phone or any other network connected device. The user would then select products and/or services for purchase, such as by indicating the appropriate products/services on an order form, as illustrated in FIG. 1, or placing the products/services in an electronic “shopping trolley”. The merchant would await an indication from the user that they were proceeding with the transaction, such as by activating a “Buy” button or the like.

If th user has not already provided the merchant with general billing information, the merchant would request such information. For example, the us r may be presented with a billing form as shown in FIG. 2. In this regard, the number entered into the card or account number field is the universal number. It is to be appreciated that the universal number as used in FIG. 2 is purely for the purposes of illustration of the invention, and that this number may be any number whatsoever. By entering the universal number, the user's privacy is maintained, as all users of this credit/debit system would share the same credit/debit card number, so that it is not possible to distinguish or differentiate the identity of the card owner by this number.

The merchant's site would recognize that the number submitted was the universal number. Preferably, a command would then be sent from the merchant's site to the user's browser to automatically launch a console program, which establishes a secure connection between the user and the credit provider's system and also causes the console screen as shown in FIG. 3, to be presented to the user.

Alternatively, however, the console program need not be automatic, and the user may manually initiate this program, either from within their browser (in the case of a plug-in program) or by launching a stand-alone program.

The overlying console screen or window of the console program provides a graphical interface for the user to communicate with an authentication server. This authentication server is preferably independent from the one or more credit providers. In other words, a third party may control the authentication server, and the associated credit authorisation, for one or more credit providers. Alternatively, the authentication server is under the direct control of the credit provider.

In this regard, according to the present embodiment of the invention, the user would enter their unique information, such as a user name and password. This communication betw en the user and the authenticating server is a secured connection, so that the merchant is not able to access the user name or the password.

Onc the authentication server receives the unique information from the user it verifies that information in the usual manner. If the authentication is positive, a single use transaction number is generated to be used in the transaction between the purchaser and the merchant. This transaction number may be randomly generated or retrieved from a predetermined list of numbers. For each successive authentication performed by the authentication server, a new transaction number is generated. It is preferably generated by the authentication server, although it may be generated by any other means or server associated with the authentication server. It is also to be appreciated that the transaction number is described as single use, in that it is generated to be used only once. In other words, it is not intended to mean that once a particular number is generated it is never regenerated again. It is possible for the same number to be regenerated and used in a different transaction.

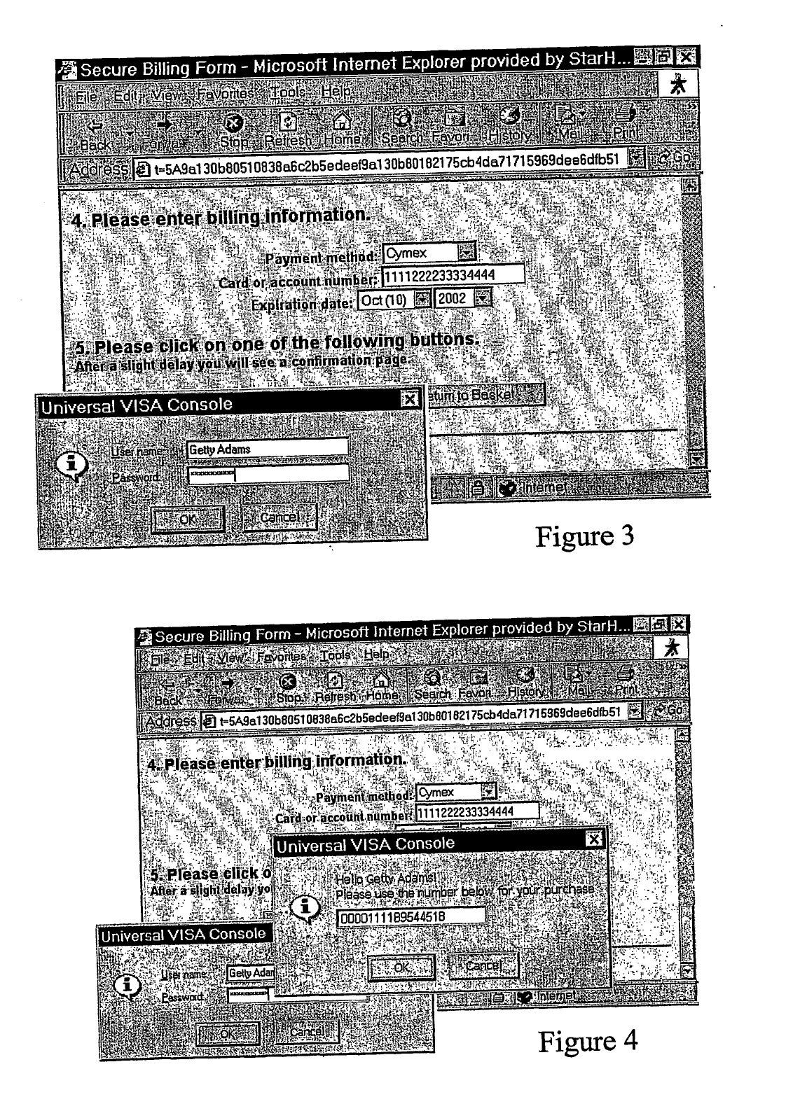

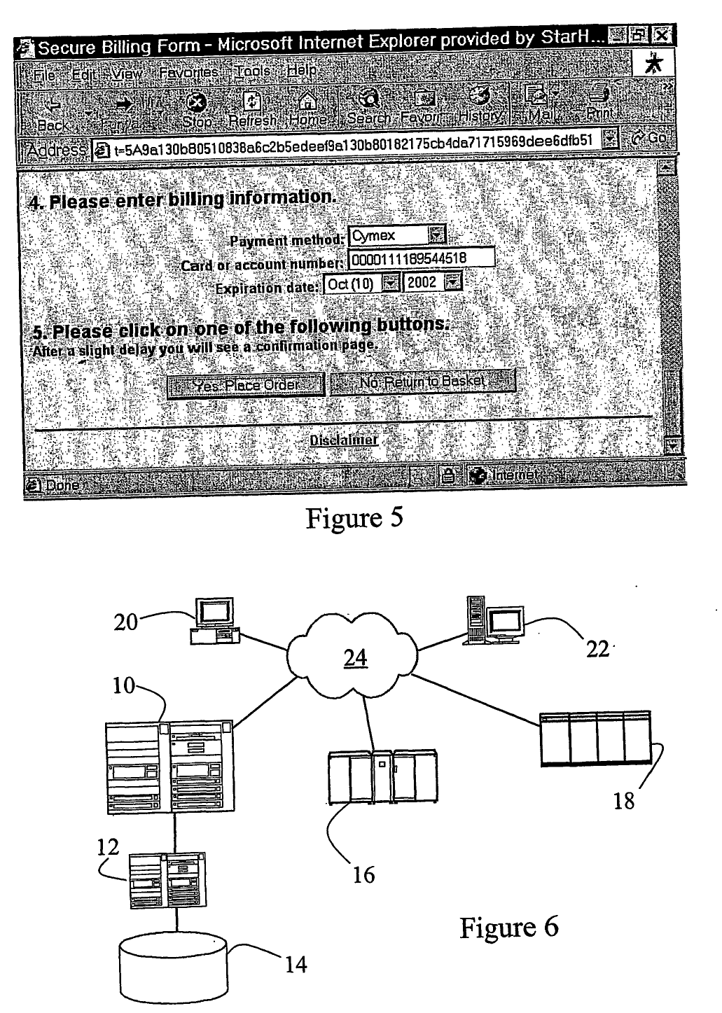

Preferably the transaction number is sent from the authentication server to the user, as illustrated in FIG. 4. The user would use this transaction number in the impending transaction, such as by modifying or replacing the number in the “card or account number” field as illustrated in FIG. 5. Preferably, however, the console program automatically places the transaction number in the “card or account field” for the user's ease of use. To then place the order, the user could activate the “Yes: Place Order” field.

The transaction number preferably comprises two components: the first series of digits identify the bank or card issuer, while the last series of digits constitute a transaction number unique to the current transaction. For example, a transaction number “4569 4093 6011 0523” could comprise bank code “4569 4093 6” and transaction number “011 0523”.

The m rchant would then process the cr dit card transaction as usual by submitting th transaction details, including th transaction number, for approval. Preferably the authentication server provides this approval or another server associated therewith. Therefore, where the third party is controlling the authentication server, it is the third party's authenticating system that signals to the merchant's server whether the transaction is approved or rejected.

An overview of the architecture of the system of the first embodiment, and its operation, is illustrated schematically in FIGS. 6 to 9. Referring to FIG. 6, the system includes a payment gateway 10, which includes an authentication server 12 with a user ID and password database 14, a credit authentication system 16 and the card issuer host system 18. The user's computer 20 and the merchant's server 22 communicate with each other and with the system of this embodiment by means of the internet 24.

Communications between the user's computer 20 and the merchant's server 22 are SSL (Secure Sockets Layer) data encrypted transmissions. Those between the merchant's server 22 and the payment gateway 10 (for authorization & data capture) are SSLv3 authenticated, encrypted transmissions. Transmissions between the payment gateway 10, the authentication system 16 and the card issuer host system 18 comprise authorization/data capture transmissions.

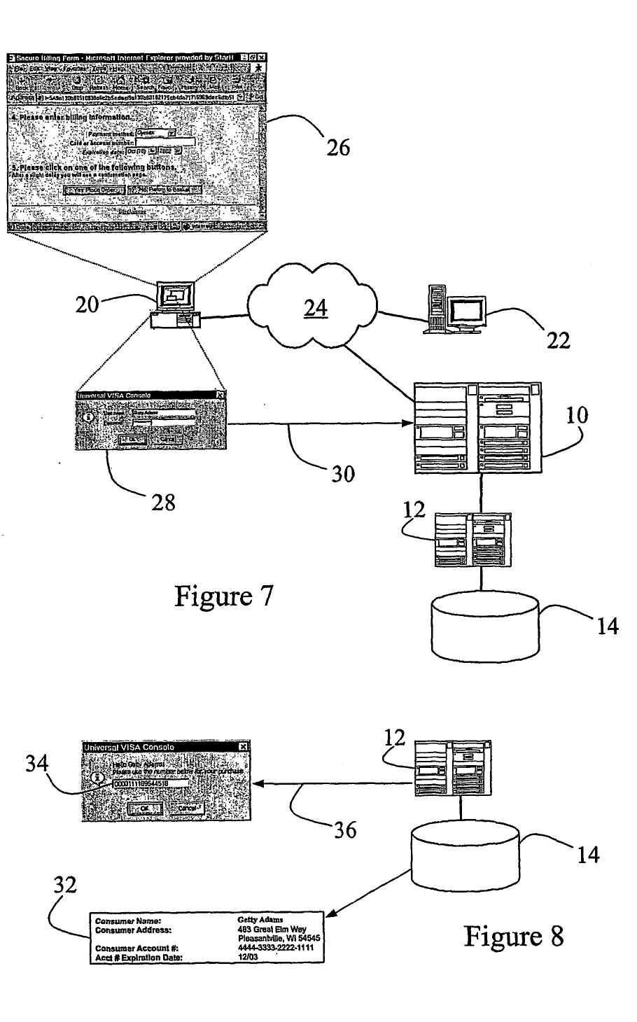

Referring to FIG. 7, the order form 26 (similar to that of FIG. 1) is presented by merchant server 22 to user computer 20. As described above, when the user provides the universal number and that number is identified as such by the merchant server 22, the merchant server 22 launches a console program 28, which prompts the user to enter user name and password information. That information is sent as an SSL data encrypted transmission 30 via the payment gateway 10 to the authentication server 12. Referring to FIG. 8, if th user name and password details provided by the us r are genuine, the authentication server 12 authenticates the user's ID and accesses the us r's account details 32. The authentication server 12 then generates a transaction number 34 and sends the transaction number by SSL data encrypted transmission 36 to user computer 20.

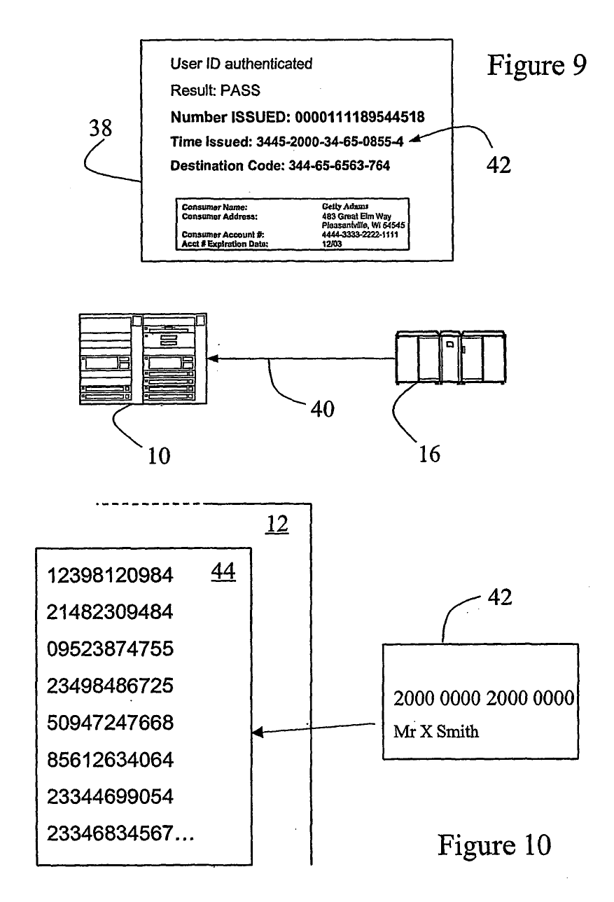

As described in the context of FIGS. 4 and 5, the user then inserts the received transaction number in the order form 26. The order form is sent to the merchant's server 22 and from there to the credit authentication server 16 for authorisation, by means of an SSLv3 encrypted transmission. Referring to FIG. 9, if the credit request is authorised by credit authentication server 16, credit authentication server 16 sends a credit authorisation 38 as an SSLv3 authenticated, encrypted transmission 40 to payment gateway 10. The payment gateway 10 then forwards the credit authorisation 38 to the merchant server 22.

Importantly, however, the credit authorisation 38 includes a “time issued” field 42, that is, the time at which the transaction number was issued. In this embodiment, before forwarding the credit authorisation 38 to merchant server 22, the payment gateway 10 compares the time the transaction number was issued with the time the payment gateway 10 received the credit authorisation 38. Only if the difference between these two times is less than a preset maximum will the credit authorisation 38 be passed on to the merchant server 22. Thus adds a level security, as a transaction number effectively expires if not used promptly. Consequently, the transaction number is preferably both one-use and valid for a finite time only, but either of these security measures is also of value.

Therefore, it is apparent that the present invention has the ability to make use of a user's credit card account without revealing or compromising the information relating to the user's real credit information, ensuring on-line privacy from both th merchant and potential hackers of the merchant's site. In particular, it is possibl for a user to remain anonymous while making a transaction. Further, should a hacker gain access to the merchant's server and to transaction information stored on that server (should it be stored th re), the information would be useless, as it would consist of transaction numbers which would not be able to be re-used.

The present invention also provides operational robustness and ease of administration, as a single credit card number makes it simple and effective for the card issuer to manage and administer a large number of users. Also, where the authentication is via a user ID and password, there is no need for any form of digital certificate to authenticate the transaction, which reduces costs and workload. Further, the authentication information is readily altered by the user and/or credit provider, which also aids the ease of use of the system.

An additional feature of the present invention relates to the provision of a transaction slip or confirmation to the user for each transaction that is authorised. This transaction slip is preferably provided to the user via one or more pre-selected address, such as an email address and/or wireless access protocol (WAP) mobile phone browser, SMS or any other network connected address. This transaction slip would be essentially a confirmation of the transaction that was generated.

This “transaction slip” is a counter check, and is not referred to during the user's authentication process, so the fraudulent user would not know at which email account the real user would be notified. Therefore, should a fraudulent transaction take place, the real user would be notified via email of the unauthorised transaction, and hence be able to take action.

An additional preferred feature, to further ensure that the user's identity is not revealed to the merchant, is for the user to request delivery to be provided to a prearranged location, such as a particular shop or cafe that is convenient for th user. Such an arrangement would require the assistance of the particular shop or cafe in order to be viable.

Alternatively, the user could enter a “virtual address” either to distinguish him or herself from other users, or to distinguish one of his or her orders from other orders he or she places. A virtual address may or may not be a real address, as its principal function is to specify identity, not location. This is done by entering the virtual address together with a unique PIN (Personal Identification Number) or other code, separated from the virtual address by a suitable ASCII separator character, such as the “&” symbol. This character serves as a separator so-that both the virtual address and PIN (or equivalent) can be entered into the same input field. Alternatively, if all addresses are uniform in some way (e.g. never end in a numeral) and so are the PINs (e.g. comprise numerals exclusively), the system will be able to distinguish the virtual address from the PIN and the separator can be omitted.

For example, therefore, if the virtual address were “34 Moon Avenue, The Moon” and the PIN were “1234”, in this embodiment the user would enter when prompted “34 Moon Avenue, The Moon&1234”.

Vendors such as couriers, cafes or even selected or trusted merchants might provide the use of such common addresses to the purchasers (i.e. the users) for a small fee/charge per use. All users of such a payment card would then use the same virtual address; each user would be distinguished on the basis of his or her distinct PIN. The central server will recognise the various different common virtual addresses that, say, a courier company might provide, and route delivery to the courier company's server for processing. The courier company's server will then look for the “&” separated PIN, compare that PIN against a stored database where the real address of the courier's client (the ultimate purchaser or user) is found, and thus making the subsequent delivery from the merchant's warehouse to the purchaser's real addr ss.

According to another embodiment of the present invention, the credit card may also be used offline. In this embodiment of the invention, the card has another unique Offline Credit Card (OEC) Number. This OEC number may be stored on the magnetic strip of the card and/or a smart chip embedded on the cards The credit card owner can make user of the card offline, while being fully assured that the OEC number, even if it were revealed, could not be used for any on-line transactions. Separate authenticating networks for on-line and offline transactions ensure that the OEC number could not be used for any on-line transactions, effectively making it usable only for “card present” transactions.

In this embodiment of the invention, each on-line and OEC transaction would be registered and the details submitted to the user's specified address, such as an email account, mobile phone WAP address or SMS. This empowers the user with complete information on all transactions made, whether on-line or offline so that they may deactivate or activate their on-line and/or offline accounts as required.

As indicated earlier, the present invention may be over a WAP enabled mobile telephone or by SMS. In a first embodiment, the user would input a user ID and/or PIN via the phone, in the same manner as indicated above. Once verified, the user would receive a transaction number on the mobile phone browser to be provided to the merchant to complete the transaction.

An alternative embodiment of the invention, implemented on a WAP enabled mobile phone with a SIM card will now be described. To obtain authorization for a particular transaction, a secure connection is established between the user's phone and a SIM Card authentication server. A third party preferably controls this server under licence from one or more credit providers, although the credit provider may alternatively control it. The cr dit provider may also be the user's telecommunications service provider.

At this site, the user is authenticated via th ir SIM card. For ev n greater security, the user may be authenticated using their SIM card as well as a PIN input by the user. If the authentication is positive, then a transaction number is generated. This transaction number may be sent to the user via the secure connection for completing the transaction with the merchant in the manner indicated in the previous embodiment.

Alternatively, instead of the transaction number being provided to the user, it may be maintained on the authentication server (or another server associated therewith) and is related with the merchant's order form once it is received by the authentication server. The transaction would then be authorised by the authentication server, if applicable. The merchant is then preferably sent the transaction number to hold as the credit card number for the transaction, and also a transaction slip nay be sent to the user via their pre-selected email and/or mobile phone address. It is also to be appreciated that this alternative verification process may be applied to the previous embodiments of the invention herein described. Variations and additions are possible within the general inventive concept as will be apparent to those skilled in the art.

For example, instead of the console screen appearing, according to another embodiment of the invention, a link may be provided to the user to the credit provider's server or another server controlled by the user's credit provider in order to complete the authorisation at that site.

Also, on-line merchants may themselves provide the universal payment cards of the present invention.

Further, the obtaining of unique information from the user need not occur by the user entering their user name and password. For example, the authentication may be initiated without user input, such as by the automatic detection of som unique feature that the authentication s rver might process in the form of installed hardware/software.

In addition, it is possible to have more than one universal number, but such that a plurality of users still use each universal number. For example, a plurality of different credit providers may utilise the present invention and each credit provider may have their own universal number that they provide to their customers.

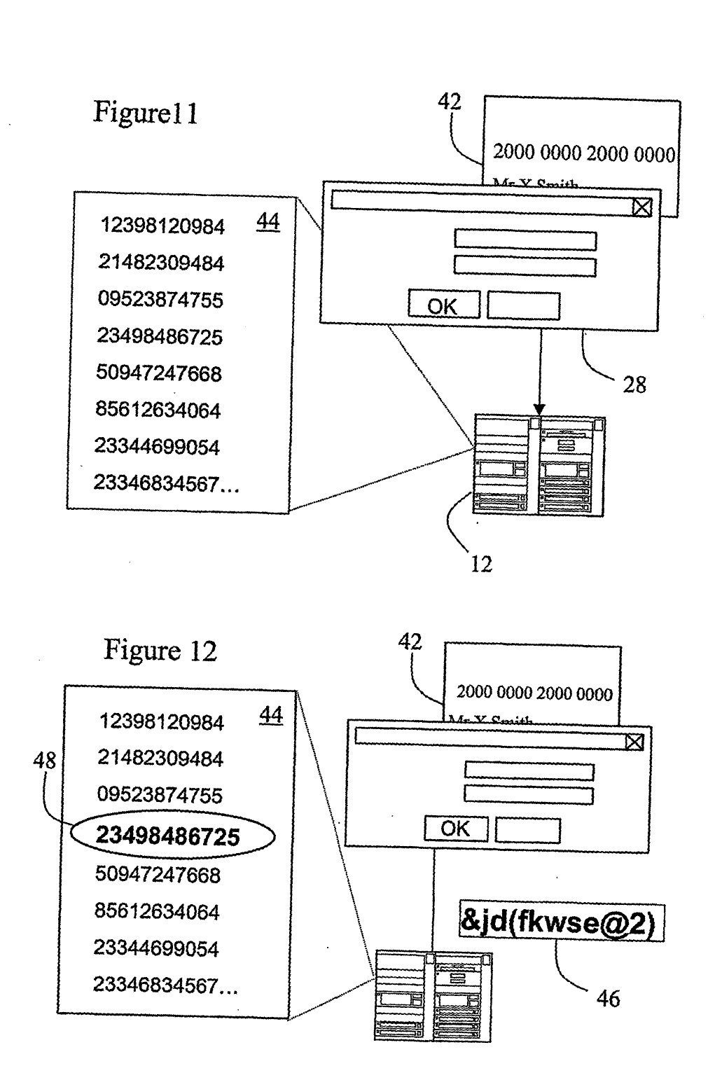

Referring to FIG. 10, according to another embodiment of the present invention, the transaction number is provided to the user/purchaser in a two step process. The authentication server 12 maintains, for each user/purchaser 42, a list 44 of already generated possible transaction numbers in a database reserved for this purpose. Referring to FIG. 11, the user 42 enters the required unique identification information (that is, a user name and password) in console screen 28 and clicks “OK” to send that information to the authentication server 12. Referring to FIG. 12, the authentication server 12 responds—assuming that the ID information was valid—by providing or generating a selection or “morph” code 46 comprising an alphanumeric string, in this example “&jd(fkwse@2)”. The morph code 46 is then used by authentication server 12 to select which of the transaction numbers in the reserved list 44 is to be used (in this example transaction number 48). This selection can be by any suitable method; a checksum could be generated from th morph code, the value of which specifies the entry in the reserved list of transaction numbers to be used. Alternatively, the morph code 46 could be used as a random number generator seed, the resulting random number specifying which entry in the reserved list of transaction numbers to be used.

Alternatively, rather than relying on a reserved list of available transaction numbers, the morph code 46 could be added to the universal (or common) number based on ascii values of each character to yield the transaction number.

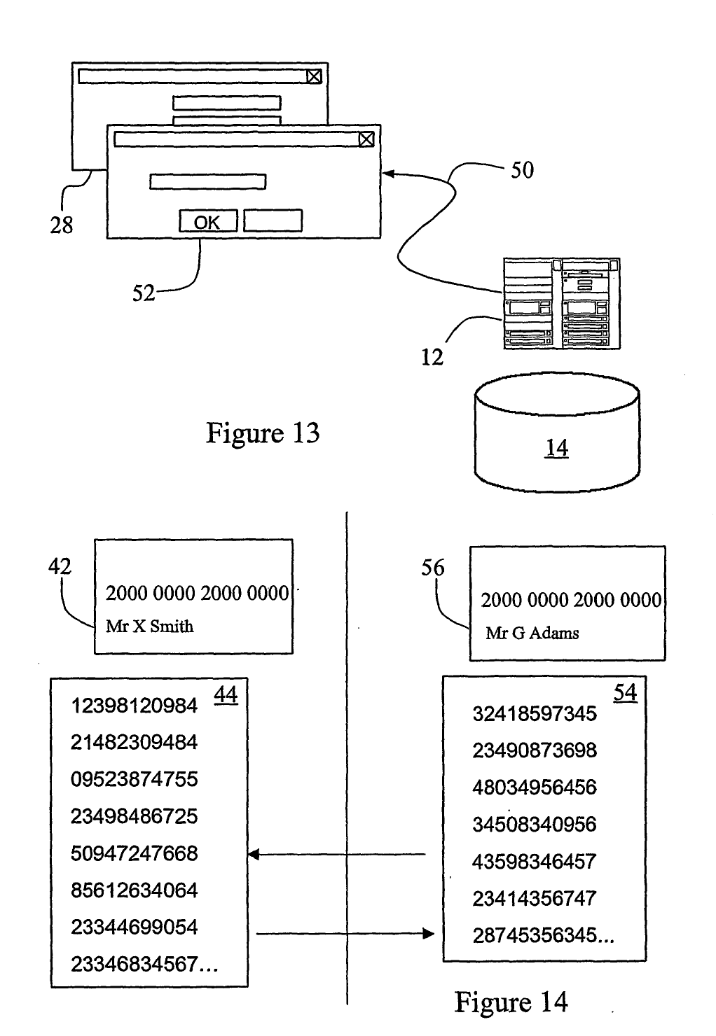

Referring to FIG. 13, the transaction number 48 so specified is then “activated”, that is, recorded as valid for use by user 42, and sent 50 either to th user (for subsequent submission to the merchant) where it is displayed in window 52, or directly to the merchant (not shown), as described in the above embodiments.

After the transaction is completed, the activated transaction number 48 is deactivated and thus rendered useless.

At any subsequent log-on, the authentication server 12 ensures that the issued morph code is different from any morph code to that user previously, to randomise the transaction number selected for each transaction.

Referring to FIG. 14, furthermore the reserved number database for each user is also periodically interchanged with that of another user, enabling the cardholder's submitted transaction number to be truly single-use, disposable and secure for each transaction. Thus, the reserved list 44 of user 42 could be swapped with the reserved list 54 of user 56 so that user 42 has reserved list 54 and user 56 reserved list 44; alternatively, in typical system with many users, the reserved lists can periodically be randomly re-assigned amongst the users.

As a further layer of security in any of the above embodiments, the required unique identification information (that is, the user name and password) to be sent by the user to the authentication server may include one or more “hotspots”. Each hotspot in inserted into the user name or the password by double clicking at the desired location, next to any of the characters of the user name or password. Such hotspots would not generally be recorded by the user with user name/password details and, indeed, according to the invention need not be visible on the computer screen. They are, however, agreed upon—in much the same manner as the user name and password—by the user and credit provider.

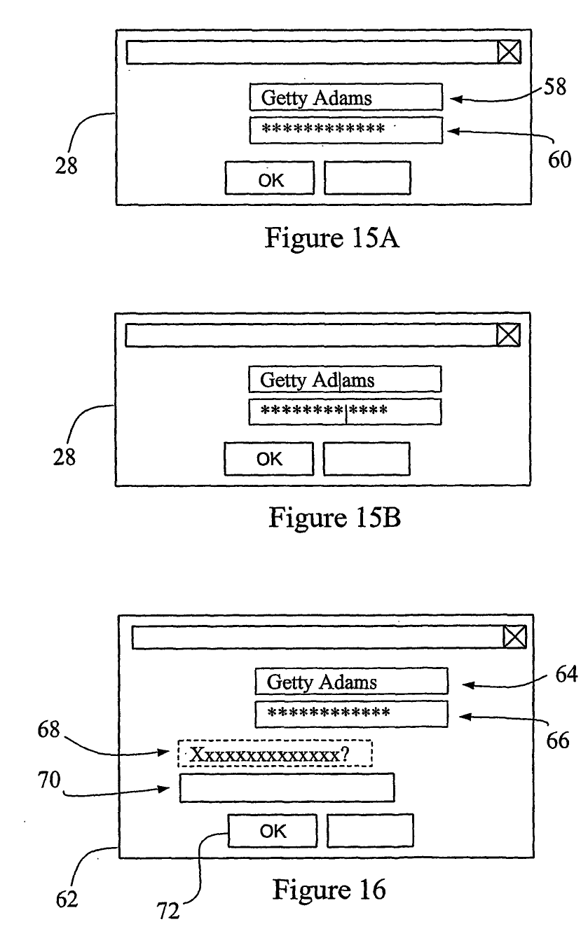

Referring to FIG. 15A, the user name 58 and password 60 are first entered in the conventional manner in th console screen 28 provided—at the prompting of the authentication server 12 or merchant server 22—for this purpose. Referring to FIG. 15B, the user then double clicks at a number of predetermined locations (in this example after the eighth character of both the user name 58 and the password 60), to insert hotspots. Each hotspot can be regarded, in fact, as a part of the respective user name or password. In the illustrated example, the locations of the hotspots are shown by means of the “|” character; however, it may be preferred that no visible character be displayed after the hotspots have been entered.

Such hotspots can also be added to the transaction nwtber itself. The transaction number will typically be received by the user in a pop-up window or console. The user can then copy the transaction number and paste it into the on-line ordering console provided by the merchant server. Before doing so (or after doing so but before selecting the “OK” button on the merchant's order form), the user can insert one or more hotspots into the transaction number by double clicking at predetermined locations (previously arranged with the credit provider). In this embodiment, without these hotspots the transaction number is incomplete and invalid.

Optionally, in addition to the usual user name and password (with or without hotspot(s)), the user can be asked a question at each log-on, at regular intervals, or when the authentication server 12 detects abnormal log-on time or log-on behaviour. This so-called “question of the day” acts, in effect, as a second level password in addition to the user name and password. The user's personal particulars, such as age, address, or even information that is specifically designed for the above purposes, such as most memorable moment, favorite car make, tc. can be selected to becom answers to “question of the day” passwords. During the initial us r r gistration (to register or first log-on to the authentication server/party), the user is asked a series of questions and informed that the answ rs will constitute “question of the day” log-on fields in addition to the user's user name/password information.

These questions are then rotated to accompany the username and password that the user must input to log-in, so that the user is asked a different “question of the day” at regular log-on attempts.

Rotation of this “question of the day” effectively increases the level of security associated with log-on authentication via keyboard or keypad devices.

Thus, referring to FIG. 16, at log-in to the authentication server 12, the user is presented with a log-in console screen 62 containing the usual fields 64 and 66 for user name and password respectively.

In addition, console screen 62 includes a “question of the day” 68, to which the user must respond by inserting the correct answer in field 70 before selecting the “OK” button 72. Only if both the password and this answer are correct for the user name will the user be logged into the authentication server 12 and provided with a transaction number (as described above).

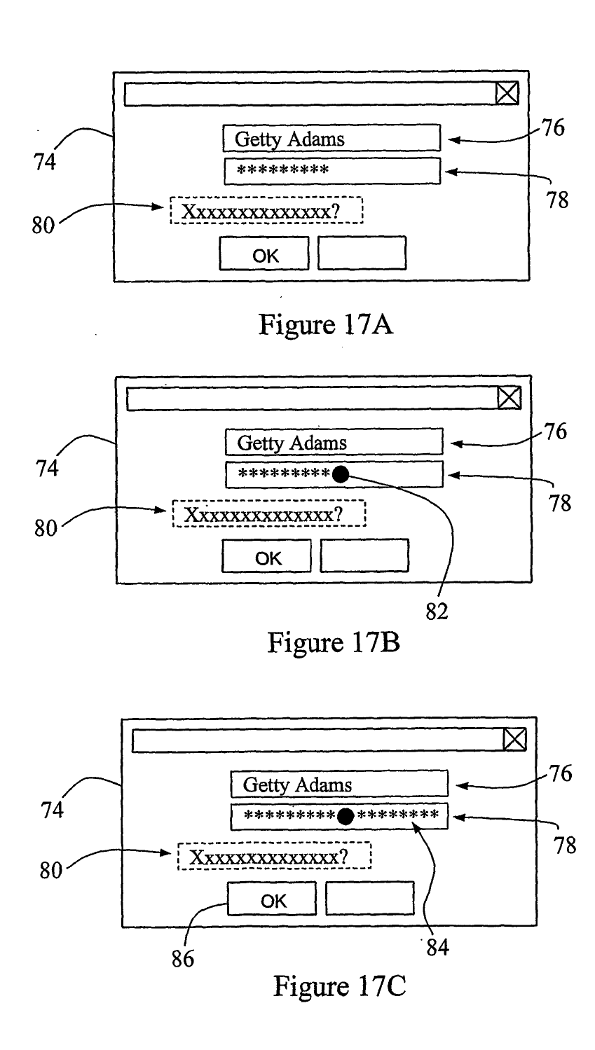

In one alternative approach, the answer to the “question of the day” is entered by the user following and in the same field as the password. Thus, referring to FIG. 17A; the user is again presented with a login console screen 74, which contains input fields 76 and 78 for user name and password (with or without hotspot(s)) respectively. The console screen 74 also includes a “question of the day” 80. As shown in this figure, the user enters his or her user name and password in fields 76 and 78 in the usual manner.

Referring to FIG. 17B, as soon as the password has been entered, a field separator 82 is preferably inserted after the password in the password field 78. This field separator 82 is preferably automatically insert d by the authentication server 12 as soon as th correct number of password characters (nine in the illustrated example) are detected, wh ther or not the password has been correctly spelt.

Referring to FIG. 17C, the user then enters the answer 84 to the “question of the day” 80 immediately after the field separator 82; the user continues typing the answer 84 directly after the password has been entered as though the answer 84 were merely an extension of the password. The answer 84 is masked in the same manner as the password. In the illustrated example, the answer 84 so entered could read, for example, “21061965”, such as might be the required answer if the “question of the day” 80 were “What is your Date of Birth? [ddmmyyyy]”. After the user has entered the required answer 84, the user selects the “OK” button 86 to complete logging on. As in the approach described with reference to FIG. 16, the “question of the day” 80 is regularly rotated, and is based on information obtained from the user during initial user registration.

In another alternative approach similar to that described above by reference to FIGS. 15A and 15B, identification also requires a password with a hotspot (where both password and hotspot are supplied initially by the user), but the password and hotspot are not stored by the system, on the authentication server or otherwise. Rather, in this approach the system initially generates and stores two “hash” values (the first from the password and the second from the hotspot position) and a large pool of pseudo-passwords (from both the password and hotspot position) for later use. This is done when the user's account is established and preferably on the authentication server. Any suitable rules or algorithms may be used do generate these hash values and pseudo-passwords.

The rule or rules used to select the pseudo-password for activation from the pseudo-password pool can be adapted from any suitable existing algorithms such as MD5 from RSA Security. However, since a large library of different rules or algorithms can be used to determine which pseudo-password pool is to be selected, hacking to determine the rule or algorithm is made much more difficult.

Thus, for example, a user might enter the password/hotspot “ace|3” (where the “|” character represents the location of the hotspot), on the basis of which the system could generate a first hash value of 10,000 from the password, a second hash value of 4 from the hotspot position, and the pool of pseudo-passwords:

Passwordl

Passwordlo2ijr

Erpji335

Erpfgopj

567-095346pas

Thisispassword

The brown fox234

None of these pseudo-passwords is—initially—activated, and none is ever valid as a password that can be entered by a user when prompted for a password at log-in.

When the user attempts to log-in, he or she first enters the appropriate user ID in the log-in dialog box user name field (say, for example, “ace_sing”).

When the user tabs to the password input field in the log-in dialog box, the user ID is transmitted to the authentication server. The authentication server responds by selecting and activating onelof the pool of pseudo-passwords, and by generating two numbers from the first hash value, the first number X to be stored on the authentication server, the second number Y to be sent to the user client device/terminal. X and Y are generated by means of two separate rules or algorithms, which are themselves session specific. A library of such algorithms will be cycled through effectively randomly so that the relationship between password via the first hash value to X and Y is more difficult to predict. In addition, as a result X and Y will almost certainly differ from previous X and Y values at each log-in session.

In this example and for this specific session, the algorithms might be:

X=(first hash value)×2/4 and

Y=(first hash value)×2/8,

so that, again in this example where the first hash value is 10,000, X=5,000 and Y=2,500.

The authentication server then determines a third value that reflects a relationship Z between the values of X and Y. In the simplest case, this might be merely the difference between X and Y. Thus in this example, Z=X−Y=2,500.

A further algorithm is used to compute a factor R from this Z value, and Z is then modified according to R, preferably either by reducing or increasing Z by the value of R. Suppose, therefore, that an algorithm is used in this example that produces an R value of 32.55 from a Z of 2,500. If, in this case, Z′ equals Z minus R, Z′=2,500−32.55=2,467.45.

Until now the system has used only the first hash value in the generation of X, Y, Z, R and Z′. Now, however, the system uses the second hash value (from the hotspot position) to determine the correct place where the Z′ value should be in a sequence of numbers, to represent the 5 possible hotspots in the password, ace3 (i.e. “|ace3”, “a|ce3”, “ac|e3”, “ace|3” and “ace3|”). With another algorithm or algorithms, the server generates from the value of Z four (i.e. one less than the number of possible positions) numbers, using another algorithm or set of algorithms, that are close to and within a pre-determined maximum deviation from Z. These might be, in this example where Z=2,500:

2,670 2,355 2,493 Reserved 2,841

The second hash value (4 in this example) determines where the system places Z′ in the “reserved” position in this number sequence.

This number sequence is th n transmitted to the client device (e.g. the user computer), while the user inputs into his or her computer the original password and hotspot. If the hotspot is inserted correctly, all the numbers in the number sequence:

2,670 2,355 2,493 2,467.45 2,841

are increased or decreased (in this embodiment increased) by the R value, 32.55, thereby creating the modified number sequence:

2,702.55 2,387.55 2,525.55 2,500 2,873.55.

That is, if Z was decreased by R to produce Z′, the number sequence should be increased by R to produce the modified number sequence (and vice versa).

The modified number sequence is transmitted to the authentication server, extracts the number (viz. 2,500) located at the position in the modified number sequence indicated by the second hash value (viz. 4), and compares that number with the value of Z (either stored or regenerated from X and Y).

The values of R and Z′ were selected in this example for clarity; in actual operation, the values of Z′ and R would preferably be generated such that the number sequence does not show a recognisable pattern (though all the numbers would still be increased or decreased by the same R value to obtain the modified number sequence to be transmitted back to the authentication server).

Importantly, since the number sequence that represents the possible hotspots in the password (five in the example of the password “ace3”) are always different, and the numbers themselves deviate little from one another in value, it is difficult to derive the real position of the hotspot via tapping into the system and inspecting the number sequence. Thus, a hacker cannot gain access into the system ven if in poss ssion of the first and second hash values.

When the authentication server detects a match between Z and the number in the reserved position in the modified number sequence, the selected pseudo-password is released, the us r is authenticated and log-in proceeds.

Thus, the user need not remember to change passwords, since—from the user's point of view—a single password can be used. However, the hotspot position might be changed periodically for added security.

In this approach, therefore, the system has three fail-safe mechanisms:

i) System access is not dependent on a single password, but from a large pool of pseudo-passwords;

ii) Selection of a single pseudo-password from such a pseudo-password pool can be determined by any suitable algorithm, so the relationship between the initial password and hotspot, and the ultimate pseudo-password from the pool on any particular log-in would be essentially unpredictable by a third party; and

iii) Optionally, although the user's hotspot position is preferably the same at each log-in, the numbers or characters representing that hotspot position could be changed at each log-in so that the hotspot position cannot easily be deciphered.

In another, similar approach, the user-provided password is treated by the system as comprising two portions. This can either be done at a hotspot specified by the user, or at a location dictated by the system. If dictated by the system, the location of the division can be fixed (e.g. after the nth character or such that the second portion comprises m characters), or specified and possibly varied each time the user is prompted for the password. For example, therefore, a user might provide the password “PASSWORD123” and be informed by the system (or specify by means of a hotspot) that the password will be divided such that the second portion comprises four characters, viz. “D123”. These last four characters may be described, therefore, as “cut-away” from the password overall.

When the system prompts th user for th password, he or she is requir d to enter only the first portion, i.e. the password without the cut-away portion or, in this example, “PASSWOR”.

The system—preferably only if the correct first portion has been entered—then prompts the user for information concerning the second or cut-away portion. The requested information might be, for example, the entire second portion (in this example “D123”), a particular character—such as the third character—of the second portion (in this example “2”), or some other combination of the characters of the second portion.

Preferably the system inserts a password dot (comparable to field separator 82 shown in FIG. 17B) immediately after the user has correctly entered the first portion, before then prompting for the desired information concerning the second portion.

In another approach, instead of the answer to a “question of the day” or a password, the user is prompted to enter a “Passphrase”. The Passphrase is preferably initially supplied by the user, such as when the account is established. Each time the user attempts to log-in, the system requests either that the user enter the entire Passphrase (as though it were a password), or a specified portion or portions of the Passphrase. For example, if the Passphrase were “this is my passphrase”, and the user were prompted for the third word of the Passphrase, the user would have to enter “my” to establish his or her identity.

Optionally, the system could designate a particular portion of the Passphrase to be entered initially at each log-in, display a password dot after that portion has been entered correctly, and prompt the user for one or more other portions of the Passphrase as described above.

According to a still further embodiment of the present invention, a user uses a WAP or SMS enabled mobile phone together with a personal credit or debit card and discloses his or her personal credit (payment) card number to merchant, irrespective of where the user conducts the financial transaction (be it a physical store, on the Internet or otherwise). In th case of a WAP telephone, upon receiving the credit authorization request, the credit issuer server causes the iWAPGS server to send an alert to the user's WAP mobile phone of the impending transaction, to which the user replies by sending a (preferably prearranged PIN) authentication code that verifies (and authenticates) to the card issuer that the transaction is indeed effected by the user (and not some other party), so that the card issuer's server can complete the transaction. Only if the authentication code is submitted will the card issuer approve the transaction. Once the transaction has been completed, the user receives a second iWAPGS transaction notification that informs the cardholder of the details of the completed transaction information.

In effect, the user's credit card number is useless in both Internet and card-present transactions until the user submits the authentication code via a WAP mobile phone. This system can potentially reduce card-present card fraud (which is very much higher than web-based card fraud) from fraudulent practices such as card skimming. This WAP payment card system can also be implemented for use with the “morph code” approach described above.

The iWAPGS server transaction system can also be adapted for similar, transaction-based computer processes, such as when a computer user attempts log-in onto a certain computer server/network. When the user attempts to log-in using a User ID and password, the targeted server can also send (via the iWAPGS server) an alert to the user's mobile phone, where the user can simply reply via SMS or WAP protocol with a “Yes” or “No” confirmation, or a prearranged verification PIN number, confirming or disavowing the attempted access to the server.

Only when the user replies with a valid confirmation answer via the correct mobile telephone would the iWAPGS server grant the user access to the computer server/network to which the user is attempting log-in. This approach is similar to the iWAPGS server waiting for a confirmation reply from the user (in that case, purchaser) via a mobile telephon prior to the authentication and clearance for payment for the common/universal payment card system.

According to another embodiment of the present invention, the user sends a universal or common number (discussed above) as the payment number to the merchant, for the purpose of effecting a financial transaction. However, prior to the submission of such a common payment number, the user first logs onto a web server for authentication (by the card issuer). A common number submitted without the user's first logging onto—and gaining authentication from—the card issuer server is completely useless for any transaction. Via authentication, the card issuer will issue a transaction PIN number, that is only valid for one transaction and is discarded after the transaction is completed. This transaction PIN number is (preferably automatically) placed in any (predetermined) one of the existing data fields other than the payment or credit card number data field on the merchant's online purchase form (or any other electronic form that requires the user to submit information, such as payment number, shipping address etc.). The user (or preferably the user's electronic wallet program) could, for example, enter the PIN number in the “Name” field, and rely on the PIN number to identify the user.

Where the PIN number is automatically placed in a predetermined one of the existing data fields, the PIN number would be separated with a ASCII symbol such as “&” (or any other appropriate symbol) to allow the card issuing server to correctly identify the PIN from the existing data field, such as the “Name” field. This allows the user to submit (after authentication with the card issuing server/web-site) a common credit card number to the merchant, when in fact the card issuing server would have placed an unique, single-use transaction number and/or PIN within one of the data fi lds normally required by the purchaser to input on the merchant's shopping cart and/or online purchase form, separated by a “&” ASCII symbol.

Thus, the user uses the common payment number, and after authentication of his or her identity through logging on, instructs the card issuing server to issue another transaction PIN for use with the common number submitted to the merchant for that transaction. The common number AND the transaction PIN number (which is in reality encapsulated together within a pre-selected data in the online form) is then used for the authentication of the impending transaction.

The common number may consist of a running series of numbers assigned for a group of cardholders that might belong to a similar geographical location, country, or some other common similarity. Use of the common number provides the cardholder with the benefits of not having to disclose any personal financial information, and so be anonymous when making purchases online.

Thus, users can share a common payment card number, yet each user is still correctly distinguished and his or her transactions authenticated and approved.

Modifications within the spirit and scope of the invention may readily be effected by persons skilled in the art. It is to be understood, therefore, that this invention is not limited to the particular embodiments described by way of example hereinabove.

The claims defining the invention are as follows:

1. A method of authenticating a transaction between a purchaser and a merchant on an on-line network, including the steps of:
the purchaser sending a transaction request from a mobile telephone having a SIM card;
receiving said transaction request from said purchaser including unique identification information relating to said purchaser; and
authenticating said transaction request and, if authenticated, providing the purchaser with a transaction number, different from the purchaser's credit/debit card number, which the purchaser uses in order to effect the transaction;
wherein said unique identification information relating to the purchase is obtained via said SIM card.

2. A method as claimed in claim 1, wherein the unique identification information relating to the purchase is obtained via said SIM card and a PIN entered by said purchaser.

3. A system for undertaking transactions in an on-line environment, including:
a plurality of credit or debit cards, such that the cards have identical physical card numbers;
an authentication system for authenticating purchases to be made using any respective one of said cards, said system being operable:
to receive and authenticate unique identification information relating to and provided by the user of said respective card, said unique identification information being not physically associated with said respective said card; and
for a positive authentication, to provide said user with a transaction number to be provided to a merchant as a card number, such that the transaction number is different from the physical card number.

4. A system as claimed in claim 3, wherein the transaction number is randomly generated and only able to be used for a single transaction.

5. A system as claimed in either claim 3 or 4, further including a transaction approval requesting means for transmitting an approval request to a portable device of said user, said approval request comprising a request for an approval response from said device indicative of said user's approval of said transaction, whereby said transaction can be disapproved if said approval response if not provided by said user.

6. A system as claimed in claim 5, wherein said approval response comprises any one of said identical physical card number, a regular card number, a personal identification number and a password.

7. A system as claimed in either claim 5 or 6, wherein said device is a mobile telephone.

8. A system as claimed in any one of claims 3 to 7, wherein said plurality of credit cards each includes an off-line credit card number that may only be used for offline credit transactions.

9. A system as claimed in claim 8, wherein said off-line credit card number is stored on said credit card.

10. A system as claimed in claim 9, wherein said off-line credit card number is stored on a magnetic strip on said respective credit card, in a chip embedded on said respective credit card, or both on a magnetic strip on said respective credit card and in a chip embedded on said respective credit card.

11. A system as claimed in any one of claims 8 to 10, wherein each of said credit cards has a separate credit account for on-line transactions and off-line transactions.

12. A method of authenticating a transaction between a purchaser and a merchant on an on-line network, wherein the purchaser is requesting the transaction from a mobile telephone with a SIM card, including the step of:
authenticating the purchaser's credit via said SIM card.

13. A method as claimed in claim 12, including authenticating the purchaser's credit via the SIM card and a unique PIN.

14. A method for a purchaser to effect a transaction with a merchant, said method involving:
said purchaser submitting a request for a transaction number, said request including identification information relating to said purchaser;
said purchaser receiving said transaction number if said request has been authenticated; and
providing said transaction number to said merchant in order to effect the transaction;
wherein said transaction number includes a portion of a genuine account or card number of said purchaser or a portion of a common account or card number of said purchaser.

15. A method as claimed in claim 13, wherein said common account or card number is specific to a particular financial institution, or a particular merchant.

16. A system for enabling a transaction between a purchaser and a merchant, said system having:
purchaser authenticating means operable to receive a request for a transaction number from said purchaser via a mobile telephone having a SIM card, said request including identification information derived from said SIM card, and to authenticate said purchaser based on said identification information; and
a transaction number generator operable to generate said transaction number associated with said purchaser for use by said purchaser in effecting said transaction.

17. A system as claimed in claim 16, wherein the unique identification information relating to the transaction is derived from said SIM card and a PIN provided by said purchaser.

18. A system as claimed in either claim 16 or 17, wherein said transaction number is different from a credit/debit account or card number of said purchaser.

19. A system as claimed in any one of claims 16 to 18, wherein said transaction number includes a portion of a genuine account or card number of said purchaser, or a portion of a common account or card number of said purchaser.

20. A system as claimed in claim 19, wherein said common account or card number is specific to a particular financial institution, or a particular merchant.

21. A method as claimed in either claim 1 or 14, including deactivating said transaction number after a predetermined time period, so that said transaction number is made unusable even if not yet used.

22. A method as claimed in any one of claims 1, 14 or 21, wherein said transaction number is selected from an existing set of such transaction numbers.

23. A method as claimed in claim 22, wherein said transaction number is selected from said set of transaction numbers according to either a predetermined selection code or a selection code generated as needed.

24. A method as claimed in claim 22, wherein said set of transaction numbers is specific at any time to a single user.

25. A method as claimed in either claim 1 or 14, wherein, when said request is submitted from a device with a display, said identification information includes one or more hotspots, each hotspot located at a respective predetermined location adjacent to a character of said identification information.

26. A method as claimed in claim 25, wherein each of said hotspots is input by double clicking at said respective predetermined location or by leaving a cursor at said respective predetermined location.

27. A method as claimed in either claim 25 or 26, wherein the respective location of each hotspot is invisible after its entry.

28. A method as claimed in either claim 25 or 26, including receiving said transaction number, modifying said transaction number by adding at least one hotspot to said transaction number, and providing said transaction number so modified to said merchant.

29. A system as claimed in either claim 3 or 16, wherein said system is operable to deactivate said transaction number after a predetermined time period, so that said transaction number is made unusable even if not yet used.

30. A system as claimed in any one of claims 3, 16 or 29, wherein said transaction number is selected from an existing set of such transaction numbers.

31. A method as claimed in any either claim 1 or 3, wherein said request includes address information and qualifying data, said address information indicative of said purchaser and said qualifying data indicative of a further party.

32. A method as claimed in claim 31, wherein said further party is a customer of said purchaser.

33. A method as claimed in either claim 31 or 32, wherein said address information is fictitious.

34. A method as claimed in either claim 31 or 32, wherein said address information corresponds to a real address.

35. A method as claimed in any one of claims 31 to 34, receiving said address information and said qualifying data are entered into the same input field.

36. A method as claimed in claim 35, including receiving said address information and said qualifying data separated by at least one character.

37. A method as claimed in claim 36, where said address information and said qualifying data are stored in a single database cell.

38. A method as claimed in either claim 36 or 37, where said database cell is stored in a single column in a database.

39. A method of authenticating the identity of a user to a server in an on-line or other telecommunications environment, including the steps of:
establishing a user account with an associated user identification information and receiving, from said user, a password;
generating a pool of pseudo-passwords on the basis of said password and a code derived from said password;
receiving a log-in request from said user at a user device including said user identification information;
activating a pseudo-password from said pool of pseudo-passwords and generating a set of one or more numbers, wherein one of said set of numbers is derived from said code according to a rule;
transmitting to a user device said set of numbers;
entering said password into said user device and modifying said set of numbers according to said password and an inverse of said rule at said user device to produce a modified set of numbers;
transmitting said modified set of numbers to said server, said modified set of numbers including said code if said password has been entered correctly by said user;
releasing said selected pseudo-password and effecting user log-in if said modified set of numbers includes said code.

40. A method as claimed in claim 39, wherein said password includes a hotspot with a position in or relative to said password.

41. A method as claimed in claim 40, including locating said code in said set of numbers on the basis of said hotspot position.

42. A method as claimed in either claim 40 or 41, wherein said code is generated from a first hash value derived from said password independent of said position of said hotspot and a second hash value derived from said position of said hotspot.

43. A method as claimed in any one of claims 39 to 42, including generating said code by means of a session specific rule.

44. A method of effecting a transaction between a purchaser and a merchant, involving:
providing purchaser account information to said merchant;
said merchant requesting transaction approval from a credit issuer or agent thereof;
said credit issuer sending an authentication request to said purchaser; and
said purchaser responding to said authentication request by sending authentication data to said credit issuer;
wherein said authentication data comprises a predetermined first portion of a password or phrase supplied by said purchaser and a requested second portion of said password or phrase.

45. A method of effecting a transaction between a purchaser and a merchant, involving:
receiving a request for transaction approval from said merchant;
sending an authentication request to said purchaser; and
receiving authentication data from said purchaser;
wherein said authentication data comprises a predetermined first portion of a password or phrase supplied by said purchaser and a requested second portion of said password or phrase.

46. A method as claimed in either claim 44 or 45, wherein said first portion is delimited by a hotspot previously supplied with said password or phrase by said purchaser.

47. A method of authenticating the identity of a user to a server in an on-line or other telecommunications environment, including the steps of:
receiving a log-in request from said user including unique information relating to said user;
authenticating the log-in request, and if authenticated, providing said user with a log-in number, which said user uses in order to log-in to said server.

48. A method of authenticating the identity of a user to a server in an on-line or other telecommunications environment, including the steps of:
sending to a mobile telephone or other portable communications device of said user an authentication request;
deeming user identity verified if said user responds to said request by sending a suitable response from said mobile telephone or other portable communications device.

49. A method as claimed in claim 48, wherein said server sends said request and receives said response via a gateway corresponding to said mobile telephone or other portable communications device.

50. A method as claimed in claim 49, wherein said gateway is an iWAPGS server.

51. A method as claimed in any one of claims 48 to 50, including requiring that said response be received within a predetermined time after said request is sent and deeming any subsequent response to said request unsuitable.

52. A method of effecting a transaction between a purchaser and a merchant, involving:
providing purchaser account information to said merchant;
said merchant requesting transaction approval from a credit issuer or agent thereof;
said credit issuer sending an authentication request to said purchaser; and
said purchaser responding to said authentication request by sending authentication data to said credit issuer;
wherein said authentication data comprises a predetermined first portion of a password or phrase supplied by said purchaser and a second portion of said password or phrase, said first portion being submitted over a first channel and second portion being submitted over a second channel distinct from said first channel.

53. A method of authenticating the identity of a user, involving:
said user receiving an authentication request for authentication;
said user responding to said authentication request by submitting authentication data;
wherein said authentication data comprises a predetermined first portion of a password or phrase supplied by said user and a second portion of said password or phrase, said first portion being submitted over a first channel and second portion being submitted over a second channel distinct from said first channel.

54. A method as claimed in either claim 52 or 53, wherein said first and second channels are separate portions of a computer screen.

55. A method as claimed in either claim 52 or 53, wherein at least one of said first and second channels comprises a mobile telephone or other portable communications device.

56. A method as claimed in claim 55, wherein said first channel is a mobile telephone or other portable communications device and said second channel is a computer.
